(19) United States
(12) Patent Application Publication
(10) Pub. No.: US 2023/0410071 A1
(43) Pub. Date: Dec. 21, 2023

(54) System, Method, and Program Product for Creating and Awarding Tokenized Credentials

(71) Applicant: Joshua Richard Lange, Saint Petersburg, FL (US)

(72) Inventor: Joshua Richard Lange, Saint Petersburg, FL (US)

(21) Appl. No.: 17/842,299

(22) Filed: Jun. 16, 2022

(51) Int. Cl. G06Q 20/12; G06Q 20/38; G06Q 20/10; G06Q 20/22

(52) U.S. Cl. CPC G06Q 20/1235; G06Q 20/3821; G06Q 20/3827; G06Q 20/10; G06Q 20/389; G06Q 20/223; G06Q 20/381; G06Q 2220/00

(57) ABSTRACT

The present invention relates to a method, system, and program product related to creating and issuing digital credentials that represent an accomplishment and are linked to one or more digital assets on a peer-to-peer network, such as a blockchain. The method and system combine the features of micro-credentials, scholarships, and digitalization of assets into a single utility.

### FIELD

The present invention relates to a method, system, and program product related to creating and issuing digital credentials that represent an accomplishment and are linked to one or more digital assets on a peer-to-peer network, such as a blockchain.

### BACKGROUND OF THE INVENTION

The cost of tuition and motivation to complete online courses is a challenge for billions of people worldwide, in addition to the often costly and inaccurate transfer of verifiable credentials across institutions. The United States is facing a particularly acute education financing crisis where higher education loan debts have reached 8% GDP or $1.8 trillion dollars, affecting 46 million Americans as of 10 Jun. 2022. Furthermore, adults changing careers oftentimes have little evidence of the vast array of activities and skills that they have gained—and likewise youth, especially from low-income populations—have little evidence or support in relation to building a portfolio of verifiable micro-credentials. Until this invention, credentials have been simply paper records that representing an accomplishment of some kind, created and issued by an institution or party that could establish something that occurred in the past. Likewise, the mechanisms for ‘merit-based’ scholarships and education funding have been limited to fiat currencies and centralized, permissioned systems.

### SUMMARY

The object of embodiments of the present invention is to ensure immutability and transferability of an accomplishment while operationalizing education funding directly to individuals or groups through digital assets. The method and system in the present invention: (i) creates the possibility for digital and digitized assets to be linked to accomplishments through a credential (ii) allows users to design, issue, and apply for verifiable credentials, and (iii) tokenizes accomplishments for micro-scholarships and education financing.

An object of embodiments of the present invention is to empower public and private institutions, families, and individuals to sponsor other individuals or groups such as students with motivating tangible rewards through a peer-to-peer verifiable digital credential linked to other assets.

In embodiments, the method and system of tokenizing credentials is generally related to a software application (program product) connected to a peer-to-peer system such as a blockchain. In the specific embodiment referenced throughout, there are two registered users: ‘students’ and ‘sponsors.’ The ‘sponsor’ user connects their cryptowallet or device to the application; uploads an image; and fills out a form to create an award based on their own title, description, criteria, expectations for evidence, expiry date, amount of tokens linked, and amount of credentials (in one embodiment: ‘badges’) to be published. The sponsor then ‘publishes’ the credential and the smart contract both creates a unique identifier and holds the tokens as well as copies the credential information on a graphical interface. This creates the first distributed peer-to-peer transaction using, for example, a math-based asset such as Bitcoin or Ethereum.

Once the credential is published, in the exemplary embodiment (called non-fungible digital badge or NDB) the ‘student’ users may search for or receive a link to the information about the credential including the preview image and unique identifier code, and fill out an application form that may include different questions and expectations to submit evidence to the Sponsor. The Student user in embodiments must also connect a cryptowallet or device before filling out the application, as both a method of identity verification and necessary process to receive any tokenized credentials. When the Student user submits the application form via the program product, the information goes to the Sponsor (or sponsor-approved third party) who views and decides which applicant(s) receive the tokenized credentials.

In embodiments, when the Sponsor or Sponsor-approved third party decides who receives the badges, another transaction on the blockchain occurs and the tokens (both fungible and non-fungible) are transferred to the chosen Student. The Student user then claims the credential and tokens through another transaction and they now have in their wallet or device 1) a verifiable record of their accomplishment, scholarship, or micro-credential and 2) digital or digitized assets promised as part of the award. When the Sponsor creates an NDB, they also decide when to initially publish the badge and the expiration of the badge. In the exemplary program product that enables NDBs, if it is past the expiration date, any published badges and linked assets are returned to the Sponsor minus a fee enabled through the smart contract.

In embodiments, education loans, fees, and other costs can be directly paid in advance, afterwards, or while the student is studying; this process thus creates a portfolio of stackable, verifiable credentials and simultaneously opens possibilities for merit-based education financing.

Although the present disclosure has been described in terms of specific embodiments, it is anticipated that alterations and modifications will become apparent to the skilled artisan. Thus it is intended that the following claims be interpreted as covering all such alterations and modifications as fall within the true spirit and scope of the disclosure.

### BRIEF DESCRIPTION OF THE SEVERAL VIEWS OF THE DRAWINGS

FIG. 1 is a schematic diagram and corresponding flow chart of the basic process of creating a tokenized credential in the exemplary embodiment of a Nonfungible Digital Badge (NDB);

FIG. 2 is a schematic diagram and corresponding flow chart of an exemplary backend application architecture that allows for the creation of tokenized credentials in the form of non-fungible and fungible tokens associated with various defined user groups;

FIG. 3 is an exemplary schematic diagram and corresponding flow chart of a tokenized credential creation and issuance process within a software application in accordance with the exemplary embodiment of a non-fungible digital badge;

FIG. 4 are illustrations of exemplary tokenized credentials in the embodiment of non-fungible digital badges.

### DETAILED DESCRIPTION

Skilled artisans will recognize that the figures' elements have been portrayed for clarity and simplicity rather than being rendered to size. Some of the dimensions of the elements in the drawings, for example, may be exaggerated in comparison to other elements to aid understanding of embodiments of the present invention. The program product components in the drawings have been represented in the drawings by conventional symbols where appropriate, showing only necessary details to understand the embodiments of in order to avoid confusing the disclosure with details that will be readily apparent to those of ordinary skill in the art.

The accompanying figures are incorporated in and form part of the specification, and serve to further illustrate embodiments of concepts that include the claimed invention, as well as explain various principles and advantages of those embodiments, in which like reference symbols refer to identical or functionally similar elements throughout the different views. The best mode contemplated by the inventor of carrying out the invention, i.e. a software application to create non-fungible digital badges, is set forth in the description.

### Credentials as Smart Contracts

The term ‘credential’ as used here signifies a type of digital image that represents an accomplishment recognized by an outside source such as an employer, university, or association. A credential is typically construed as an image with aspects that form it as a certificate or badge which is then saved as a PDF or printable file in a computer system. The aspects used to verify credentials have traditionally been names, dates, signatures, brandmarks, stamps, and visual design features to name a few. With the rise of digital credentials such as Credly, Badgr, and IMS Open Badges, there is usually an embedded hyperlink or unique code that leads to metadata within the credential itself or on a private database, either on or off a blockchain.

Australia now has a National Framework for digital credentials and other lands such as the European Union have technical frameworks in formation such as the Europass Digital Credentials Infrastructure. A non-exhaustive list of existing formats for digital credentials that may also be used with the type of credentials claimed include:
Academic credits
Alternative credentials
Boot camps
Certificates
Complements to degree programmes
Digital badges
Micro-certificates
MicroMasters
Nano-degrees
Professional/industrial certificates
Sequences of courses
Stand-alone units of learning
Verified certificates
   And may represent learning from various delivery modes such as:
Online
Face-to-face
Blended or Hybrid

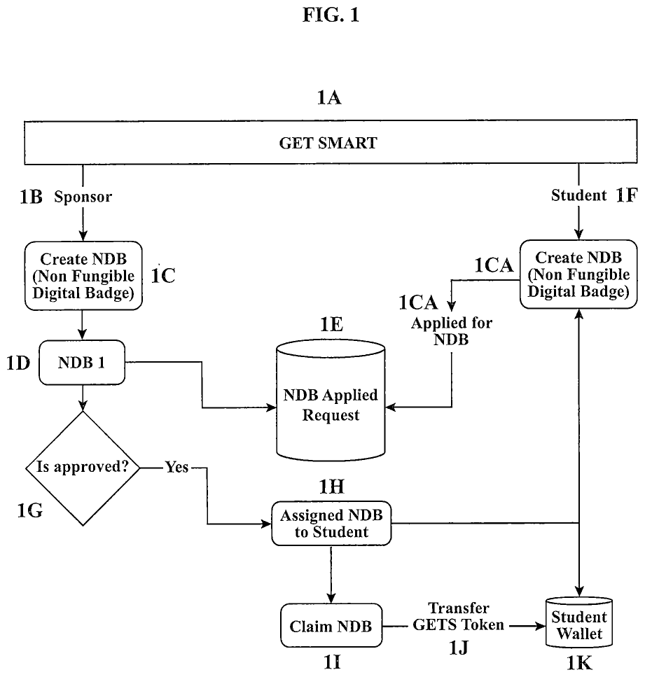

The system and method described of creating a credential linked to other assets in claim 1-3 and FIG. 1-3 uses smart contracts. In embodiments, a smart contract may be a computer protocol intended to digitally facilitate, verify, or enforce the negotiation or performance of credible transactions without third parties. In embodiments, smart contracts may also allow for the creation and/or destruction of tokens. Although the exemplary embodiment in FIG. 1 uses an ERC 1155 or multiutility token on the Ethereum blockchain which allows for both fungible and non-fungible token creation within the same smart contract, smart contracts can be mediated through other blockchains, distributed ledgers, or peer-to-peer systems yet to be developed.

### Digital Assets as Fungible and Non-Fungible Tokens

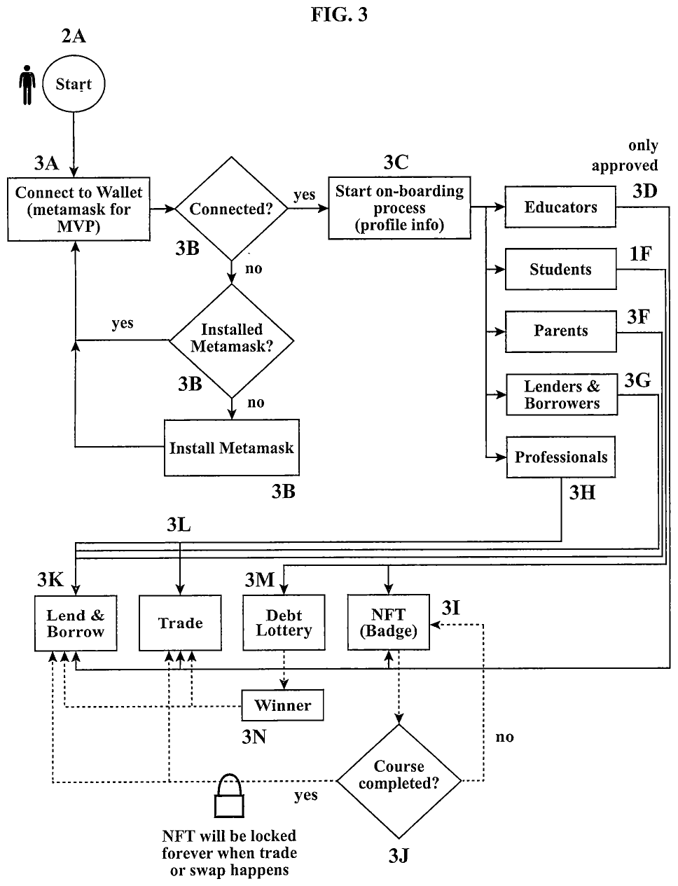

Digital assets, as referred to in claim 1, describe any text or media that is formatted into a binary source and includes the right to use, adapt, or transfer. Likewise, digitized assets as referred to in claim 1 refer to any tangible or intangible object that is formatted into or represented by a binary source and includes the right to use, adapt, or transfer. In both cases, the assets can be fungible (e.g. cryptocurrency) or non-fungible (e.g. NFT), and math-based or non-math-based. Non-Fungible Tokens (NFTs) such as in FIG. 3 refer to a unique digital identifier that cannot be copied, substituted, or subdivided. NFTs are recorded in a blockchain, and used to certify authenticity and ownership of digital or digitized assets. Likewise with the concept of ‘soulbound’ tokens, which as conceived have the properties of NFTs but are non-transferable, in other words cannot be sold or traded like NFTs. This difference has no implications for the present invention, as 1) they both require a blockchain to create, and 2) the digital identifier on the credential refers to a non-transferable accomplishment even if the token or NFT is transferable.

A token is a type of “smart contract” that runs on a blockchain network (such as Bitcoin, Ethereum, Solana, Avalanche, and Algorand to name a few). As such, it is a collection of code that is linked to a database. An issuer may maintain the database in some embodiments. In others, a consensus mechanism is used. Consensus is the validation framework for tokenized credentials. There are a variety of consensus mechanisms (or protocols) that may be used to verify transactions recorded in a blockchain. A few non-limiting examples of these mechanisms for example Proof of Work, Proof of Existence, Proof of Stake, Practical Byzantine Fault Tolerance, DAG (Directed Acyclic Graph), Proof of Brain, Proof of Existence to name a few; however, other protocols may be used in accordance with exemplary embodiments of the present invention.

Tokens, like other digital assets, may represent everything from loyalty points to vouchers and IOUs to actual physical goods. In the NDB embodiment, any user can buy and link badge-enabling utility tokens to credentials with digital currencies (e.g. Bitcoin, Ethereum) or other digital/digitized assets. Buying, selling, trading, giving tokens and other digital assets are mediated through various devices. Devices may include such physical and virtual items necessary to implement the devices in claims 4-5, such as a cryptowallet or device, mobile phone, tablet, virtual lenses, hardware or software program to name a few. Reference is made to ‘cryptowallet or device’ throughout for clarity.

In the NDB embodiment in FIG. 3, the utility token price of the native token is pegged to the native digital currency on the Ethereum blockchain through the program product using the Metamask cryptowallet. In another embodiment the value of a credential could be pegged to a different exchangeable utility or commodity such as a digital currency, stable coin, game token, affiliate program or bonus program to name a few. Tokens can also be used as tools for engaging with other smart contracts, such as in-game cards, collectibles, and points. Tokens may be accepted in trade or commerce by merchants, other businesses, and/or individuals; ‘staked’ into prize pools, lotteries, investment pools; used for yield-farming, or any other commercial or non-commercial utility as seen in FIG. 3.

FIG. 1 represents an exemplary embodiment of the steps used to implement the process of creating a tokenized credential via a smart contract.

In FIG. 1A ‘Get Smart’ is the exemplary name of the software application (program product) that enables the method and process to create and issue tokenized credentials in the embodiment of Non-Fungible Digital Badges (NDBs). The first example end user, represented in 1B, Sponsor, is an exemplary title of the user who creates and issues tokenized credentials. The Sponsor signs on with a cryptowallet or device and transacts with the platform via a smart contract. Through a form the Sponsor, in 1C Create NDB, authors the initial draft of the digital badge on the platform. Included in this may be the feature of any number of tokens linked to the digital badge, and the potential to apply for it.

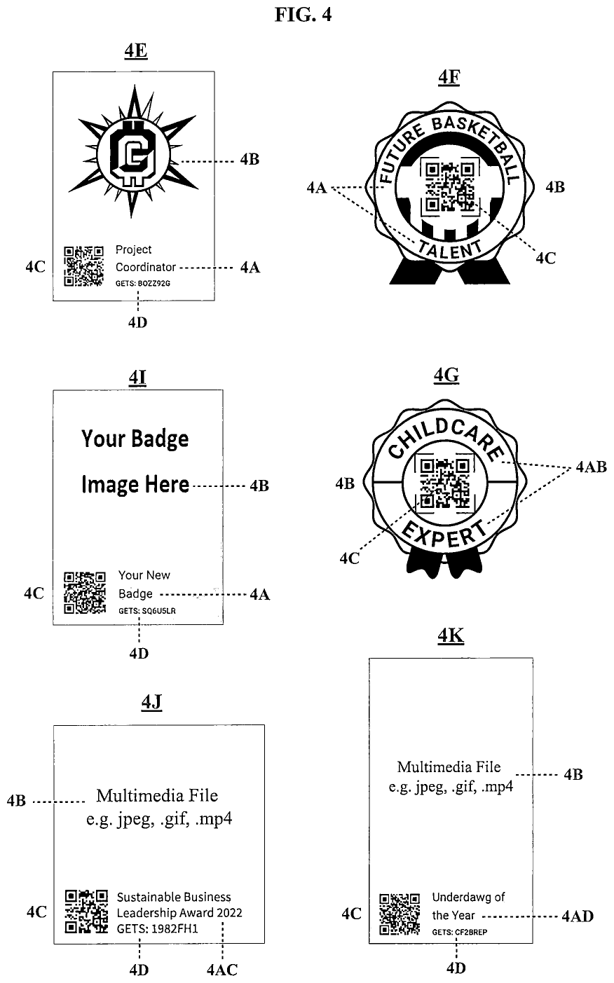

The Sponsor transacts with the system again, 1D NDB 1, and the tokens or other digital assets are then put on hold by the platform, ensuring through the smart contract that the transfers are timely and secure. FIG. 4A-D illustrates the exemplary embodiment of a published tokenized credential. In the program product this is a Digital Badge in the form of a Non-Fungible Token that is linked to another digital or digitized asset through a smart contract enabled by the program product.

The 1E NDB applied request is the function where the software application publishes the badge on a website or other channel, thus enabling communication between Sponsor and Student or peer-to-peer to publish a credential. These credentials may or may not be available on a search engine or website, and require what can be referred to as transaction fees or gas (GWEI, BTC, ALGO, SOL, to name a few) depending on the blockchain to defined platform providers or exchanges in order to function.

In FIG. 1F Student is an exemplary title of the user who applies for and claims the present invention of claim 5. This user aims to get recognized for an accomplishment or apply for a future potential accomplishment. For example the Student is ready for the next level and has achieved something great or even micro, and would like a digital credential. Or, the Student may be someone in student debt distress, and could receive tokens via the digital credential and pay off that debt. Or the Student may be a teacher at a school, in the form of a person taking professional development courses and needing a way to pay for them as the school's budgets were cut.

In this exemplary embodiment, the Student in FIG. 1CA applies for the award created in FIG. 1C or claims the award shown in FIG. 1I via the program product or other device of claim 5. Amongst all the candidates who, in one embodiment, studied hard to earned their tokens, connected to the platform via their cryptowallet or device, followed the criteria to earn the badge, and, via the graphical user interface, cryptowallet or other device, submitted an application for a tokenized credential. Through the platform the Sponsor receives the application and can store, view, and transfer it across applications or devices.

Then the Sponsor user may, as shown in FIG. 1D-G for example approve the application or deny it, thus ‘issuing the badge’ as defined in the prior art. This inventive step in claims 4-5 and shown in FIG. 1D-H is where a choice function is represented in the program product that allows Sponsor users to approve or deny applications from Student users. FIG. 1H shows this choice function calling the blockchain to transfer the tokens and the non-fungible badges or other credentials to other users either immediately or over time. The Sponsor may also, through a button or other mechanism within an embodiment of claim 5, choose the initial start date and expiry date of the publication of the credential and other aspects related to the smooth operation of a any recognition of accomplishment.

FIG. 1H represents the first technical process on the blockchain or platform of transferring the NDB from one user to another. The Student user in the NDB embodiment as represented in FIG. 1I claims the digital assets and NFT assigned by the Sponsor. Further FIG. 1J shows the transfer process through a peer-to-peer system of a digital asset from the Sponsor to the Student in the form of a schematic for the test token (GETS) on the Ethereum blockchain.

The user's cryptowallet or device illustrated in FIG. 1K is the final destination of the NDB and tokens. In this embodiment, the Student receives the digital assets, tokens, NDB or other credential, thus cycling back to the applicant's cryptowallet and closing the transaction. Whereas FIG. 1 illustrates the system giving the Sponsor user, who connected their cryptowallet or device in FIG. 1A, control over the transaction, this can also be done automatically by technically linking the program product to a software such as a Learning Management System. In this embodiment, once the course is completed as shown in 3M, The Student user or user receiving the prize may use it according to the possibilities that the platform product provides. In the exemplary embodiment shown in FIG. 3, this includes functions 3I Lend and Borrow, 3J Trade, stake in a 3K Debt Lottery, or 3N swap tokens. In this embodiment, the digital assets linked to the NDB are fungible, for example tokens on a blockchain. In other embodiments, the linked assets may be as previously described.

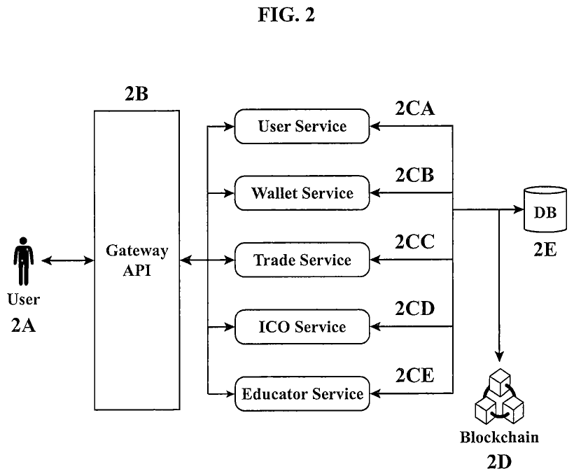

FIG. 2 is an embodiment of the shown process of FIG. 1 using a backend system including namely a blockchain. These services can later be used in a SDK as listed, with other combination, or with other software to create tokenized credentials. In the first step, FIG. 2A represents the User as represented in the embodiment of an NDB, the issuer and receiver of a credential as in FIGS. 1A and 1F, or another user such as embodied in FIG. 3. The information passed through what is seen in 2B as a Gateway API and then the several Backend services in FIG. 2CA-E that include 2CAuser service, 2CB wallet service, 2CC trade service, 2CD ICO service and 2CE educator service. These services communicate with each other and, in this case, with a blockchain as seen in FIG. 2D. From the services shown in the schematic, information travels both to and through the blockchain and to a ‘DB’ i.e. database as shown in FIG. 2E.

### Connecting to Wallet and Creating User Profile

In FIG. 3 there are multiple users added to an exemplary use of the system based on a university style credentialing framework, with various user access points, privileges, and responsibilities. As represented in FIG. 3A, the user must have a cryptowallet or device to connect to the blockchain and create a profile. The present embodiment depicted shows Metamask as in FIG. 3B as one potential cryptowallet or device that enables the transfer of tokens and other digital assets. Once the onboarding process occurs as depicted in FIG. 3C, the example user chooses a profile from a list, each having its own characteristics, rights, privileges, and other programmable features.

The drawing includes the profiles of an Approved Educator in FIG. 3D, similar to a Sponsor but according to the platform product or smart contract specifications may go through a more rigorous ‘approval’ process by the platform provider. The Approved Educator is namely a person, group, or entity that ‘designs″adapts’ verifies' or ‘transfers’ a tokenized credential through fulfilling specific criteria and has an accreditation to conduct education services of some kind. The Students in 1F represent the same functions as previously discussed in claim 2 but in the FIG. 3 example a university is assumed where there may be more rigorous security and identity protection measures taken in addition to those previously described, so may include further programmable functions in a program product of claims 4-5 for Students and additional services for IT and other third parties, with examples listed like FIG. 3F Parents, 3G lenders & borrowers, and 3H professionals such as accountants, legal services, government applications, and auditors to name a few.

FIG. 3I-N shows the various transactions that may occur to create and issue a tokenized credential, in this embodiment as an NFT (Badge) in FIG. 31 which corresponds to the process shown in FIG. 1, with the added functionality for a Learning Management System API, other connectivity solution, or other user to indicate ‘course completion’ in FIG. 3J which initiates the transaction shown in FIG. 1G-H of the token transfer. Once this occurs, the Student or user defined in FIG. 1F may: borrow tokens from users such as FIG. 3G lenders as shown in FIG. 3K; trade both fungible and nonfungible tokens received as shown in FIG. 3L; and may stake tokens into a ‘debt lottery’, fund, or staking mechanism as shown in FIG. 3M. In the embodiment, the debt lottery winner(s) are chosen by a no-loss lottery protocol as shown in FIG. 3N.

### Tokenized Credential

The present invention relates to a validated indicator of specific scholarships, accomplishments, knowledge, skills, and competencies that can be earned in formal and informal learning environments, either in the past or future. Non-Fungible Digital Badge (NDB) can be described as a digital badge, usually in the form of a non-fungible token, that is linked to another digital or digitized Asset. As such, referring to claim 2, FIG. 4 illustrates a NDB embodiment of the invention including FIG. 4A a title for the accomplishment defined by the Sponsor; FIG. 4B an image uploaded or created by a Sponsor or other user such as the Educator in FIG. 3D; in FIG. 4C a link to external data or metadata within the credential, in this case a QR code; and in FIG. 4D a unique identifier code linked to an off-chain or on-chain database where information about the accomplishment is stored. As shown in FIG. 4AB, 4AC, 4AD, and the variations of 4B-D, the visual appearance of a tokenized credential can vary in length, formatting, size, and other design variables within the scope of claim 2 and in a product of claim 5. The inventive step is not the outward-facing design illustrated by the several NDBs, but rather that these digital credentials upon creation and issuance are linked to fungible tokens via a peer-to-peer network, thus verifying the credential with non-fungibility, absent of third-party permission, technically adding to the credential tradeable value.

In embodiments, other limits or controls may also be built into the smart contract functionality of the token. For example, the token issuer may need to adjust the token ledger to account for regulatory activity. The court may seize funds, or a security issue may require reversing transactions during a compromised period. The external database may have information removed if, for example, a credential was given in error. The visual design of the credential may also be adapted to the user's specifications. In the embodiment of an NDB, for example, the tokenized credential is designed to fit the graphical interface of a mobile device or social media channel as exemplified in FIG. 4.

### Program Product for the Creation and Issuance of Tokenized Credentials

In the NDB embodiment, when a Sponsor or other defined user creates a badge, they may be required to fill out a form within the platform or choose from form options, such as:
(i) Title: in this embodiment, the NDB creator chooses a title of up to 50 characters as seen in FIG. 4A; The title appears in the NDB preview window on a preview badge;
(ii) Number of tokens connected to badge—in this embodiment, the NDB creator can add cryptocurrency tokens. In other embodiments, the credential can link to other digital or digitized assets;
(iii) Number of badges to create—in this embodiment, the NDB creator can decide how many badges to create, each of which will have several unique identifiers;
(iv) Award criteria—in this embodiment, the NDB creator (e.g. Sponsor) needs to insert the expected requirements for an applicant (e.g. Student) to be considered for a badge;
(v) Evidence—in this embodiment, the NDB creator can ask applicants for evidence of the accomplishment, either as text, media files, hyperlinks or attachment;
(vi) Sponsor name—in the embodiment illustrated, the NDB creator in FIG. 3 can be different from the “Sponsor” who in this embodiment contributes the tokens. In other embodiments, there are “approved educators” in 3D as users. For example, a university can issue the badge and tokens on behalf of an outside sponsor of digitized assets.
(vii) Preview with image—in this embodiment as seen in FIG. 4B, the NDB creator can upload any image into a 300×300 format. In other embodiments, there can be text, multimedia, or other graphics as shown in 4AB-D.
(viii) QR code or other connector to DB visible on credential—in this embodiment, as seen in 4C, the NDB has a QR code that leads to a dedicated page on an external database or blockchain. The NDB also has a “GETS” 7-digit unique identifier code that consists of both numbers and letters as shown in 4D.

In the exemplary embodiment of a program product of claims 4-5, the Sponsor user may have the additional functionality including but not limited to:
(ix) Option to create badge—in this embodiment, the Sponsor clicks a button to fetch the form
(x) Option to search for available badges—in this embodiment, all users, including those not logged in or connected to a cryptowallet or device, can search for or “Explore” badges that have been published by Sponsors;
(xi) Option to assign an Approved Educator as in 3D or other third-party to assist in the creation and issuance of credentials;
(xii) View published and awarded badges with image—in this embodiment and using a smart contract, the Sponsor has made one blockchain transaction already to produce the digital badge linked to the digital assets;
(xiii) Choose settings and make profile changes—in this embodiment, the user can make various profile edits and see which cryptocurrency account (“Wallet”) is connected to the platform
(xiv) View draft badges with image—in this embodiment, the NDB creator first inserts the award criteria and other form data, then ‘saves’ the draft. When the NDB creator is ready to publish a badge publicly, then a smart contract is initiated and the digital/digitized assets held until they are either (i) awarded to the chosen applicants, or (ii) the badge reaches the expiry date, upon which it is returned to the Sponsor's cryptowallet or device;
(xv) View awardees and a feel good sponsor display—in this embodiment, the Sponsor can see statistics on how many digital assets (tokens) they have awarded, and also a list of their awardees' profile names and cryptowallet or device addresses;
(xvi) Buy tokens—in this embodiment, the platform has a function to buy tokens from an exchange or directly via the cryptowallet or device;
(xvii) Stake tokens—in this embodiment, the platform allows users to ‘stake’ their digital or digitized assets, here represented as tokens, into a ‘staking pool’ ‘lottery’ or DeFi staking mechanism as shown in FIG. 3M. In this embodiment, the smart contract decides to which cryptowallet or devices to distribute any staking rewards (yield);
(xviii) View a published badge on the blockchain through Etherscan or other site that displays blockchain transactions and view verifiable transaction information including type and amount of digitized or digital assets linked to the badge.

In the exemplary embodiment of a program product of claim 5, the Student user may have the additional functionality including but not limited to:
(i) Using a search engine or internal website search tool, search for and find a published credential using keywords, a link, or code;
(ii) A badge list showing key information items helpful to the Student to apply: the evidence, award criteria, description, title, and amount of digital assets to name a few;
(iii) An “apply” button leads to a form which is connected to the NDB smart contract;
(iv) View of the application criteria and other text or media uploaded into the application form
(v) View of badges applied for and earned or claimed on a dashboard, in a badge backpack, or folder
(vi) Choose settings and make profile changes—in this embodiment, the user can make various profile edits and see which cryptocurrency account (“Wallet”) is connected to the platform
(vii) Buy tokens—in this embodiment, the platform has a function to buy tokens from an exchange or directly via the cryptowallet or device within the wallet represented in FIG. 3B;
(viii) Stake tokens—in this embodiment, the platform as shown in FIG. 3M allows users to ‘stake’ their digital or digitized assets, here represented as tokens, into a ‘staking pool’ or DeFi staking mechanism. In this embodiment, the smart contract decides to which cryptowallet or devices to distribute any staking rewards (yield);
(ix) View a published badge on the blockchain through Etherscan website or other site that displays blockchain transactions and view verifiable transaction information including type and amount of digitized or digital assets linked to the badge.

In the present embodiment of tokenized credentials as NDBs, people or organizations must apply for an NDB with the conditions precedent that they have a connected crypto wallet as shown in 3A-B. If required by the Sponsor, the Student user must submit evidence relevant to the badge description and award criteria by filling in the form. In other embodiments, the credential creator or issuer may insert different award variables and form information, or use other mechanisms to gather data for the credential such as Student Information Systems.

### Illustrative Examples Connecting the Various Drawings and Claims

In reference to claim 2, each badge must fulfil basic criteria to become an NDB, 4E illustrates the embodiment of a “Project Coordinator” NDB as one of several examples to follow. The descriptors are recorded into the system by the Sponsor through a form:
1) Title: Project Coordinator
2) Award Criteria: The receiver of this badge must pass the Nakamoto Institute project coordinator certificate course with 70% or above
3) Number of Tokens: The badge is connected to 0.00001 Bitcoin (BTC)
4) Sponsor/Issuer: created by the NakamotoInstitute@ni.us
5) Transaction record: 65fcidde5vafeveav2322fdeds
6) Design: JPEG file as seen in FIG. 4E

Within the exemplary program product of claim 5 operationalizing the method of claims 1-2, credentials formatted as NDBs may be based on various design templates as illustrated in FIG. 4E-G. In this instance, fictional use of the terms Future Basketball Star 4G and Childcare Expert 4F are basic illustrations that show the various titles and designs that badge creators may use with the program product. In these examples, NDBs display three unique identifiers 1) title 2) QR code 3) badge design. Although for the purposes of the patent these are illustrated in black and white, they can also be produced in colour. Likewise FIG. 4J the badge design ‘sustainable development initiative—top prize’, FIG. 4I ‘Your New Badge’ and FIG. 4K ‘Krypto the Underdawg Award for Courage’ illustrates an uploaded image, award title, QR code and GETS unique identifier with minor design alterations. These visual features on a NDB are not exhaustive and represent only a few options for further designs.

Example with a Scholarship Initiative

Let's say “the Williams sisters” have earned billions in crypto and their mother encourages them to give one million dollars to education. They never had student debt and don't care about it but have become sensitive to disadvantaged populations. As sharp entrepreneurs, they want to use their mom's advice, do some good, and get a ROI. One day the clever twins, Dolly and Parton, decide to become Sponsors. They sign up and buy tokens, then create badges in an easy-to-use flow. The Williams twins make the following NDB badges, each worth 10,000 tokens:
Williams Future Rowing Champion×20
Williams Future Tennis Champion×10
Williams Young Entrepreneur Award×30
Williams Youth Leadership Award×25
Blockchain Genius×15

The Williams write a couple sentences and the accomplishment criteria. They complete the transaction using their cryptowallet. After the badge is published, Students can find them and apply. The system processes applications from Students and the Sponsors or approved third party decide on who receives the badge and for what criteria. The badges return to tokens if not awarded and remain in the Williams' account.

On the Student side, consider the Dogevoss twins—Elon and Winkle. They come from a poor neighborhood, single parent home and have no money for college. One has received a partial Rowing scholarship to the university and the other wants to study Medicine but his Pell Grant only covers part of the costs. Both students expressed leadership in their previous activities. The twins browse for badges and find the Dolly and Parton Williams badges. They review the criteria, provide evidence, and submit their application for multiple badges. The Williams twins are inspired by the Dogevoss twins and immediately approve the badge application. Within 10 minutes the Dogevoss twins are much closer to achieving their dreams. The Dogevoss twins can copy their NDB as a JPEG or PNG, share their accomplishment across devices, or submit their NDB to an accrediting institution.

Example with an Accredited Institution to illustrate FIG. 3-4

Let's say the user Approved Educator “Big Tech Uni” or BTU buys one million Tokens at their special fixed-rate to be used for the freshmen at their university. These tokens cannot be traded, only turned into NDBs. So BTU wants to create badges for various accomplishments that align with their values, including academic grades, leadership, athletics, internships, and social initiatives. Here are the details they insert into the NDB information fields:
Tokens purchased: 1,000,000
Token current value: $1
Approved Educator fixed rate: 2-for-1
Total purchase: $500,000
No of Students: 100
Batch: Bachelor 2021-2025
Types of badges to be issued: 5
   Total badge value=$1,000,000 worth of tokens

### Types of Badges:

A—grades
B—leadership
C—athletics
D—work placements
E—social initiatives

BTU weighs the value of activities based on the student behaviors they value. Since they want to constantly reinforce good grades, they allow for up to 250 Type A badges to be created per student per year. Since a student might only take one internship (work placement) during their whole degree, BTU assigns a much larger value to that badge.

BTU can decide how many types of badges and what token-value each has. The logic goes:
1) more badges=less competition=less value
2) fewer badges=more competition=more value

BTU decides that there should be 1000 available “A” badges set aside for grades above “70%” per student in the Freshers Batch (250 potential badges per year). They create limits as follows:
A—1000 badges (1/1 ratio)×100 students=100,000
B—10 badges (100/1 ratio)×100 students=100,000
C—10 badges (100/1 ratio)×100 students=100,000
D—1 badge (1000/1 ratio)×100 students=100,000
E—100 badges (1/1 ratio)×100 students=10,000

### Total Potential Badges for 2021 Freshers Batch: 410,000

Remaining tokens in the Approved Educator wallet: 590,000

BTU can create unlimited badge names, styles and values for different groups or ‘batches’ within one of the listed services in FIG. 2-3. So, if they have a ‘batch’ of athletes, they can create an “Athletic Accomplishment” badge worth 1,000 tokens and 5,900 Athletic NDBs with the rest of the tokens in their wallet, then simply add all the students at their university to the batch.

Once the token-to-badge ratio has been decided for each Badge Type created, then the Approved Educator ‘agrees’ to the smart contract and their tokens turn into available NDBs connected to the defined batch.

If a Lender (parent, conscious alumni, etc.) as seen in 3F-H donates fungible tokens to BTU for a certain batch, then those tokens are used to create NDBs first, and then BTUs purchased tokens afterwards. So, if a group of 10 parents each lend BTU $1000 worth of Tokens for the 2021 Freshers Batch, then that becomes $2000×10=20,000 GETS. This lowers BTUs allocation from 410,000 to 390,000 tokens.

Now that embodiments of the present invention have been shown and described in detail, various modifications and improvements thereon can become readily apparent to those skilled in the art. Accordingly, the exemplary embodiments of the present invention, as specified, are intended to be illustrative, not limiting. The spirit and scope of the present invention is to be construed broadly.

1. A method comprising the creation of a digital credential representing an accomplishment, with linking capabilities to other digital assets or digitized assets and the process of designing, linking, issuing, applying for, transferring, and claiming the credential.

2. The method of claim 1, further comprising a non-fungible token or soulbound token in the form of a nonfungible digital badge that is defined by the following minimum elements: 1) link to another digital asset or digitized asset 2) hash value/message digest/database identifier 3) visual design.

3. The method of claim 1, further comprising a technical process that enables one user or set of users to create, adapt, issue, transfer, and claim the digital badges of claim 2 or the credentials of claim 1 to another user or set of users on a software application, blockchain, or peer-to-peer network.

4. The method of claim 1, further comprising a computer program product that enables users to trade or exchange credentials and their linked digital or digitized assets of claim 2.

5. The method of claim 1 and computer program product of claim 4, further comprising a device, set of devices, system, or systems and devices used in combination, to have the same effect of claim 1, namely the creation and issuance of tokenized credentials.
